(19) United States
(12) Patent Application Publication
(10) Pub. No.: US 2024/0221498 A1
(43) Pub. Date: Jul. 4, 2024

(54) METHOD AND APPARATUS FOR SUPPRESSING A FALSE POSITIVE ROADWORK ZONE

(71) Applicant: HERE Global B.V., Eindhoven (NL)

(72) Inventors: Advait Mohan RAUT, Virar West (IN); Leon STENNETH, Chicago, IL (US); Bruce BERNHARDT, Wauconda, IL (US); Jingwei XU, Buffalo Grove, IL (US)

(21) Appl. No.: 18/091,760

(22) Filed: Dec. 30, 2022

(51) Int. Cl. G08G 1/01; B60W 60/00

(52) U.S. Cl. CPC G08G 1/0125; B60W 60/001

(57) ABSTRACT

An approach is provided for suppressing false positive reports of detectable road events. For example, the approach involves receiving a detection of a roadwork zone and a time-to-live period associated with the roadwork zone. The approach also involves receiving a subsequent observation of the roadwork zone. The subsequent observation is generated based on sensor data captured by at least one sensor associated with at least one vehicle traveling within proximity of the roadwork zone. The approach further involves classifying the subsequent observation as a false positive observation based on determining that the subsequent observation is created after the time-to-live period. The approach further involves initiating a blacklisting of the roadwork zone as a false positive roadwork zone based on the false positive observation. The approach further involves providing the blacklisting as an output.

### BACKGROUND

Navigation and mapping service providers are continually challenged to provide digital maps with traffic incident reports and road-related event reports to support navigation applications and advanced applications such as autonomous driving. For example, providing users up-to-date data on road events (e.g., roadwork events/zones) can potentially reduce congestion and improve safety. Modern vehicles are increasingly capable of sensing and reporting various road-related events as they travel throughout a road network. Typically, road event reports are based on vehicle sensor data. However, there are false positive road event reports (e.g., roadwork zone reports) resulted from factors other than the reported road events (e.g., roadwork zones). For instance, although a toll plaza or ramp is not yet still classified as a construction zone due to the presence of traffic cones. Accordingly, navigation and mapping service providers face significant technical challenges to differentiating between true and false road event reports (such as roadwork zone reports), particularly when receiving reports from thousands or millions of vehicles in real-time.

### SOME EXAMPLE EMBODIMENTS

Therefore, there are needs for reducing false positive reports of detectable road events (e.g., roadwork zones).

According to example embodiment(s), a method comprises receiving a detection of a roadwork zone and a time-to-live period associated with the roadwork zone. The method also comprises receiving a subsequent observation of the roadwork zone. The subsequent observation is generated based on sensor data captured by at least one sensor associated with at least one vehicle traveling within proximity of the roadwork zone. The method further comprises classifying the subsequent observation as a false positive observation based on determining that the subsequent observation is created after the time-to-live period. The method further comprises initiating a blacklisting of the roadwork zone as a false positive roadwork zone based on the false positive observation. The method further comprises providing the blacklisting as an output.

According to another embodiment, an apparatus comprises at least one processor, and at least one memory including computer program code for one or more programs, the at least one memory and the computer program code configured to, with the at least one processor, to cause, at least in part, the apparatus to receive a detection of a roadwork zone and a time-to-live period associated with the roadwork zone. The apparatus is also caused to receive a subsequent observation of the roadwork zone. The subsequent observation is generated based on sensor data captured by at least one sensor associated with at least one vehicle traveling within proximity of the roadwork zone. The apparatus is further caused to classify the subsequent observation as a false positive observation based on determining that the subsequent observation is created after the time-to-live period. The apparatus is further caused to initiate a blacklisting of the roadwork zone as a false positive roadwork zone based on the false positive observation. The apparatus is further caused to provide the blacklisting as an output.

According to another embodiment, a computer-readable storage medium carrying one or more sequences of one or more instructions which, when executed by one or more processors, cause, at least in part, an apparatus to receive a detection of a roadwork zone and a time-to-live period associated with the roadwork zone. The apparatus is also caused to receive a subsequent observation of the roadwork zone. The subsequent observation is generated based on sensor data captured by at least one sensor associated with at least one vehicle traveling within proximity of the roadwork zone. The apparatus is further caused to classify the subsequent observation as a false positive observation based on determining that the subsequent observation is created after the time-to-live period. The apparatus is further caused to initiate a blacklisting of the roadwork zone as a false positive roadwork zone based on the false positive observation. The apparatus is further caused to provide the blacklisting as an output.

According to another embodiment, a computer program product may be provided. For example, a computer program product comprising instructions which, when the program is executed by a computer, cause the computer to receive a detection of a roadwork zone and a time-to-live period associated with the roadwork zone. The computer is also caused to receive a subsequent observation of the roadwork zone. The subsequent observation is generated based on sensor data captured by at least one sensor associated with at least one vehicle traveling within proximity of the roadwork zone. The computer is further caused to classify the subsequent observation as a false positive observation based on determining that the subsequent observation is created after the time-to-live period. The computer is further caused to initiate a blacklisting of the roadwork zone as a false positive roadwork zone based on the false positive observation. The computer is further caused to provide the blacklisting as an output.

According to another embodiment, an apparatus comprises means for receiving a detection of a roadwork zone and a time-to-live period associated with the roadwork zone. The apparatus also comprises means for receiving a subsequent observation of the roadwork zone. The subsequent observation is generated based on sensor data captured by at least one sensor associated with at least one vehicle traveling within proximity of the roadwork zone. The apparatus further comprises means for classifying the subsequent observation as a false positive observation based on determining that the subsequent observation is created after the time-to-live period. The apparatus further comprises means for initiating a blacklisting of the roadwork zone as a false positive roadwork zone based on the false positive observation. The apparatus further comprises means for providing the blacklisting as an output.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of suppressing a false positive roadwork zone, according to example embodiment(s);

FIG. 2A is a diagram of an example process for suppressing a false positive roadwork zone, according to example embodiment(s);

FIG. 2B is a diagram of an example process for de-blacklisting a false positive roadwork zone, according to example embodiment(s);

FIG. 3 is a diagram of the components of a mapping platform, according to example embodiment(s);

FIG. 4 is a flowchart of a process for suppressing a false positive roadwork zone, according to example embodiment(s);

FIG. 5 is a diagram of example map layers, according to example embodiment(s);

FIGS. 6A-6C are diagrams of example map user interfaces for adjusting and reporting detectable road events, according to various embodiments;

FIG. 7 is a diagram of a geographic database, according to example embodiment(s);

FIG. 8 is a diagram of hardware that can be used to implement a system or process described herein, according to example embodiment(s).

FIG. 9 is a diagram of a chip set that can be used to implement a system or process described herein, according to example embodiment(s).

FIG. 10 is a diagram of a mobile terminal (e.g., handset or vehicle or part thereof) that can be used to implement a system or process described herein, according to example embodiment(s).

### DESCRIPTION OF SOME EMBODIMENTS

Examples of a method, apparatus, and computer program for suppressing a false positive roadwork zone are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

As used herein, the term roadwork refers to work done in constructing or repairing roads, and the term roadwork zone refers to an area where roadwork takes place. Roadwork zones include mobile roadwork zones such as areas of roadway striping, pothole filling, tree trimming, etc. A roadwork zone can be marked by signs, channeling devices, barriers (e.g., traffic cones), pavement markings, and/or work vehicles. For instance, highway work zones can be set up according to the type of road and the work to be done on the road. The roadwork zone can be long or short term and can exist at any time of the year.

Although various embodiments are described with respect to roadwork zones, it is contemplated that the approaches of the various embodiments described herein are applicable to other road events that are external to vehicles and detectible by vehicle sensors, such as an accident detecting event, a congestion detecting event, a signage detecting event, a road divider detecting event, etc.

Service providers and original vehicle manufacturers (OEM) are increasingly developing compelling navigation and other location-based services that improve the overall driving experience for end users by leveraging the sensor data collected by connected vehicles as they travel. For example, the vehicles can use their respective sensors to detect roadwork zones on roads on which the vehicles are traveling, which in turn can be used for issuing traffic warning, updating real-time mapping data, as inputs into a mapping data pipeline process, and/or any other purpose.

Generally, roadwork zones are outlined with cones or barrels with red and white colored stripes. Vehicles (e.g., autonomous vehicles) equipped with modern sensors are able to potentially identify roadwork zone. To provide users with up-to-date data on road events (e.g., roadwork zones), navigation and mapping service providers commonly acquire road event data from various data sources (e.g., highway authorities, OEMs, etc.). Current state of art does such identification either from vehicle cameras or via pre-aggregated databases. Whether roadwork zones are identified with machine learning based automated systems or via curated manually created governmental sources, there is a problem of false positive (FP) identification. In other words, some area (e.g., a toll plaza) is not a roadwork zone but still classified as a roadwork zone, for example, due to presence of traffic cones or the like. Other example false positive roadwork zones include crosswalks, stalled vehicles or crashes, parking garages, a car wash, hazard warning signage on a sidewalk (e.g., for raised/uneven surface, holes, etc.), etc.

A false positive roadwork zone can cause autonomous vehicles to wrongly switch to a manual mode from automatic driving mode, or even cause a wrongly re-routing. Navigation and mapping service providers are facing the technical challenge of reduce false positive roadwork zones.

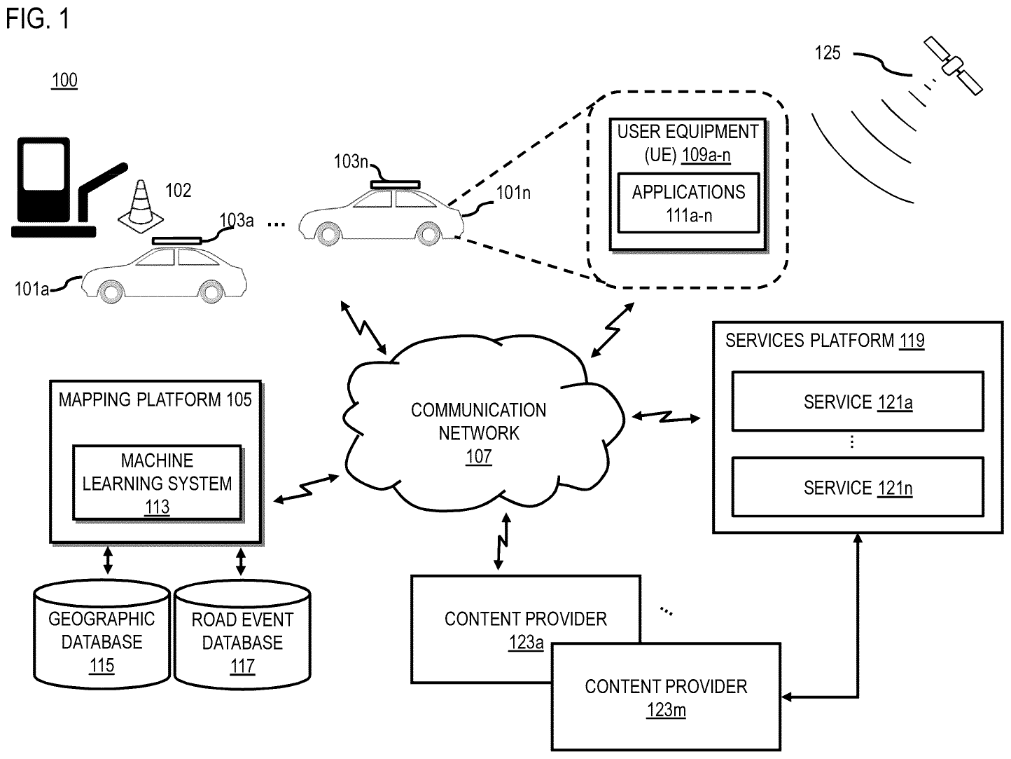

To address these problems, a system 100 of FIG. 1 introduces the capability of suppressing a false positive roadwork zone. FIG. 1 is a diagram of a system 100 capable of suppressing a false positive roadwork zone, according to example embodiment(s). The system 100 can improve map data and deliver accurate roadwork zone information to vehicles by utilizing a time-to-live (TTL) period of a roadwork zone. The TTL period has relation with respect to time taken for the roadwork. This TTL period my go from few hours to few days, depending on the type and attributes of the roadwork. In one embodiment, when the system 100 still receives vehicle observations of a roadwork zone 102 (e.g., a toll plaza with traffic cones) much longer after the TTL period, the system 100 can determine these observations as false positive roadwork zone observations.

As shown in FIG. 1, the system 100 can collect a plurality of instances of vehicle sensor data, and/or information of the roadwork zone 102 from one or more vehicles 101a-101n (also collectively referred to as vehicles 101) (e.g., conventional vehicles, autonomous vehicles, HAD vehicles, semi-autonomous vehicles, etc.) having one or more vehicle sensors 103a-103n (also collectively referred to as vehicle sensors 103) and having connectivity to a mapping platform 105 via a communication network 107. For example, the sensors 103 may include infrared sensors, LiDAR, radar, sonar, cameras (e.g., visible, night vision, etc.), global positioning system (GPS), and/or other devices/sensors that can scan and record data from the vehicle 101's surroundings for determining road event information. The vehicles 101 can include one or more types/models of vehicles belonging to any numbers of public and/or private entities.

In one instance, the system 100 can also collect the real-time sensor data, and/or road event information from one or more user equipment (UE) 109a-109n (also collectively referenced to herein as UEs 109) associated with the vehicle 101 (e.g., an embedded navigation system), a user or a passenger of a vehicle 101 (e.g., a mobile device, a smartphone, etc.), or a combination thereof. In one instance, the UEs 109 may include one or more applications 111a-111n (also collectively referred to herein as applications 111) (e.g., a navigation or mapping application). In one embodiment, the mapping platform 105 includes a machine learning system 113 for analyzing the sensor data. The sensor data collected may be stored a geographic database 115 and/or a road event database 117.

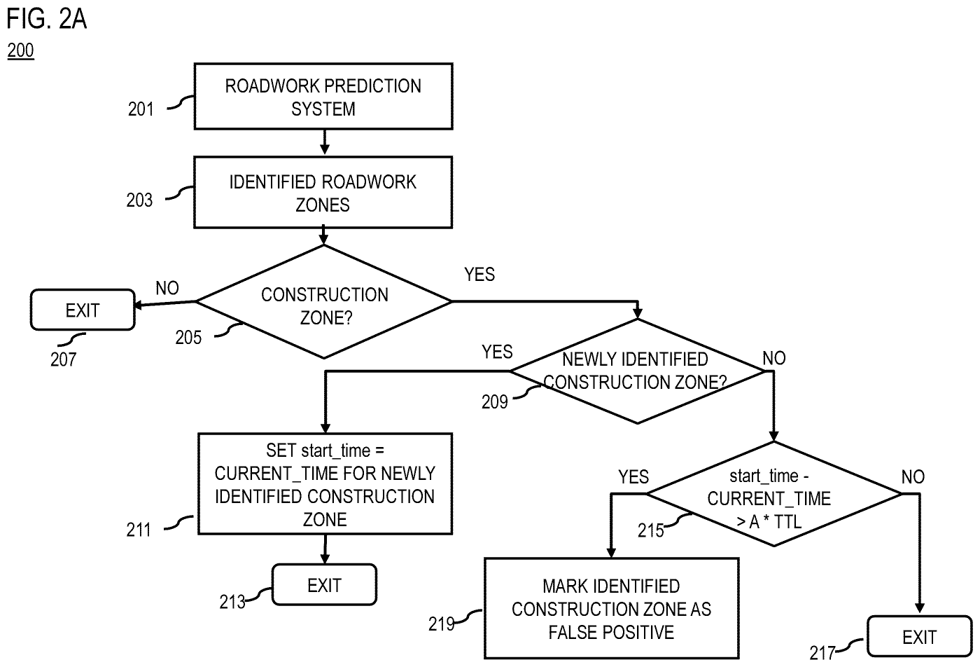

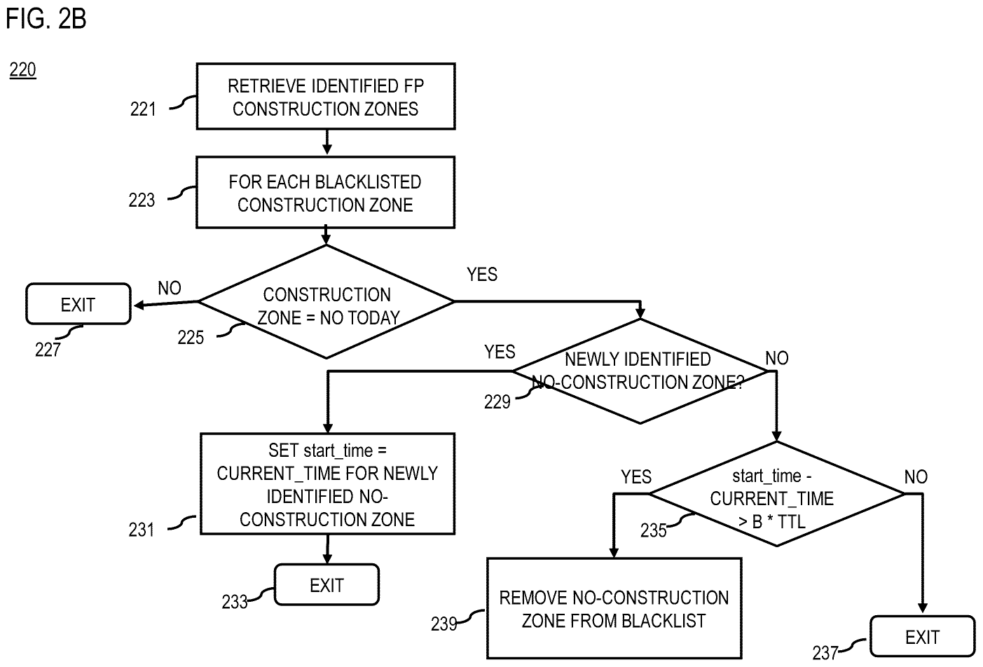

FIG. 2A is a diagram of an example process 200 for suppressing a false positive roadwork zone, according to example embodiment(s). In one embodiment, the system 100 can acquire roadwork zone sensor data/signals from vehicles 101, apply roadwork detection algorithms (e.g., machine learning models) on the sensor data/signals in Step 201, and produce an output of location(s) of roadwork zone(s) in Step 203. For example, Table 1 shows a sample output of the roadwork detection algorithm(s).

In one embodiment, a construction zone is detected when the probability is ≥0.7.

TABLE 1
460382308|Backward|FC1|LINESTRING(-76.06492843678622
39.59410349177767, −76.06448851255901 39.59439805270505)|0.0|1.0|0.0|0.7|150|33.3
460382308| Backward|FC1|LINESTRING(−76.06448851255901
39.59439805270505, −76.06401633401184 39.59466109053899)|0.0|1.0|0.0|0.7|200|33.3
460382308 Backward|FC1|LINESTRING(−76.06401633401184
39.59466109053899, −76.06353857859263 39.59491845768089)|0.0|1.0|0.0|0.7|250|33.3
460382308|Backward|FC1|LINESTRING(−76.06353857859263
39.59491845768089, −76.06303705010738 39.595146978525406)|0.0|1.0|0.0|0.7|300|33.3
460382308|Backward|FC1|LINESTRING(−76.06303705010738
39.595146978525406, −76.06252079092584 39.5953556421261)|0.0|2.0|0.0|0.7|350|66.6
460382308|Backward|FC1|LINESTRING(−76.06252079092584
39.5953556421261, −76.06198589174271 39.59553392407649)|0.0|2.0|0.0|0.7|400|66.6

The parameter hmcLink is a road link ID. The parameter direction is the direction of the road link that can be forward or backward. The parameter fc is the functional class of the road link, and can be defined as in Table 2.

TABLE 2
FunctionalClassType is a value of the type xs:
byte. The following values are supported:

1: a road with high volume, maximum speed traffic
2: a road with high volume, high speed traffic
3: a road with high volume traffic
4: a road with high volume traffic at moderate speeds between
neighborhoods
5: a road whose volume and traffic flow are below the level of any other
functional class

The parameter Geometry is the geometry of the road link, such as a line string between a pair of geographic coordinates. The parameter signObs indicates a number of sign observations on the road link. The parameter constructionYesObs indicates a number of construction zone observations on the road link. The parameter constructionNoObs indicates a number of no-construction-zone observations on the road link in an identified FP construction zone. The parameter probability can be calculated by dividing the number of construction zone observations by a total number of vehicle trips on the road link during the same time period. The parameter segmentStartDistAlongLink indicates a distance of a starting location of the construction zone from a beginning node of the road link.

The parameter confidence can be affected by the number of vehicle observations of a roadwork zone, faulty or functional vehicle sensors, weather, speed limits, etc. More vehicles observes the same construction zone, the higher the confidence level. Fewer vehicles observes the same construction zone, the lower the confidence level. The confidence level may also be dependent on the vehicle or vehicle sensor confidence level. Therefore, data sets with a higher vehicle or vehicle sensor confidence level may have a higher confidence level. For instance, a better equipped vehicle may have a higher confidence level than a lower equipped vehicle. Three different confidence level values like a high level (e.g., 99.9), a middle level (e.g., 66.6), and a low level (e.g., 33.3) may be sufficient. It may be desirable to have a higher number of confidence levels like nine levels which allow more detailed distinguishing.

In one embodiment, the confidence level may be low when a significant new information has been reported the first time by a vehicle. In another embodiment, the confidence level may be high for important or urgent information. For example, a dynamically changed speed limit on a highway can be an urgent information. As another example, a road marking change is important yet less urgent, as it takes hours or days.

In another embodiment, the confidence can be calculated as a percentage of false positive construction zone signals/reports statistically. For instance, the system 100 can assume that both faulty and functional vehicles generate construction zone signals/reports on real construction zones, while only faulty vehicles generate false positive construction zone signals/reports on non-construction roads. In other words, the system 100 can take data at time periods when the condition is definitely true or almost definitely true, and at time periods when the condition is definitely false or almost definitely false, to calculate from both numbers an approximate percentage of the vehicles reporting erroneously.

For each predicted roadwork zone, the system 100 can determine whether the predicted roadwork zone is a construction zone in Step 205. If no, the predicted roadwork zone exits the process in Step 207. If yes, the system 100 checks whether the predicted roadwork zone is first time identified as a construction zone in Step 209. The false positive suppression takes place after the roadwork detection algorithms, hence it is a post processing algorithm. The algorithm itself consist of two processes: a process of blacklisting a construction zone, and a process of de-blacklisting of the a construction zone. The set of two processes are used to process the outcome of a roadwork zone predictive model.

When the system 100 keeps on observing vehicle observations for positive construction zone much longer after a time-to-live (TTL) period of the construction zone, most likely these observations are false positives. A false positive suppression algorithm can use three parameters: (1) TTL period, (2) Parameter A that is a scaler with (>1) value used in blacklisting a predicted construction zone (e.g., using a machine learning model), and (3) Parameter B that is a scaler with (>1) value used in de-blacklisting the predicted construction zone.

The idea behind the blacklisting process/algorithm is that roadwork generally takes few hours to few days at a particular location. This time period can go up to order of few days, and for that period, sensor equipped vehicle(s) 101 which passes by the zone will send roadwork observations to the cloud and/or the system 100. If vehicles 101 keep sending roadwork observation at the same location for a much longer period then the TTL period. most likely those observations are false positive observations. The blacklisting process utilizes configuration parameters A and TTL, and it can run once in a day, or once after every few days. The blacklisting process can be performed in batch over identified construction zones, or can be performed individually over each identified construction zone. The blacklisting algorithm can run on the cloud, or within one or more individual vehicles.

During the blacklisting process, when determining it is a newly identified construction zone, the system 100 can set a start time (e.g., start_time=CURRENT_TIME) for the newly identified construction zone in Step 211, thereby monitoring a creation time of the construction zone against a time-to-live (TTL) period of the construction zone. Then the newly identified construction zone exits the process in Step 213. When determining it is an already identified construction zone, the system 100 can check whether its creation time (1) exceeds or is equal to a product of A*TTL, A=blacklisting parameter, i.e., start_time−CURRENT_TIME≥A*TTL, or (2) exceeds or is equal to the TTL period of the construction zone, i.e., start_time−CURRENT_TIME≥TTL in Step 215. If no, the construction zone exits the process in Step 217. If yes, the system 100 marks/blacklist the construction zone as false positive in Step 219.

The de-blacklisting process/algorithm works similarly as the blacklisting process/algorithm yet for removing blacklisted FP construction zones out of the blacklist. The de-blacklisting process/algorithm checks whether vehicles 101 passing by the blacklisted FP construction zones stop seeing construction on identified FP construction zones. When such observations stop, then the identified FP construction zone is removed from the blacklist.

In one embodiment, the de-blacklisting process reverses the blacklisting process by utilizing configuration parameters B and TTL, and it can run once in a day, or once after every few days. The de-blacklisting process can be performed in batch over identified FP construction zones, or can be performed individually over each identified FP construction zone. The de-blacklisting algorithm can run on the cloud, or within one or more individual vehicles.

FIG. 2B is a diagram of an example process 220 for de-blacklisting a false positive roadwork zone, according to example embodiment(s). In one embodiment, the system 100 can retrieve the data of identified FP construction zones in Step 221. For each blacklisted construction zone in step 223, the system 100 can check if the blacklisted construction zone has no construction observed there today in Step 225, e.g., CONSTRUCTION ZONE=NO). If no, the link exits the process in Step 227. If yes, the system 100 checks whether the identified FP construction zone is newly identified as a no-construction-observation zone in Step 229.

When determining if it is a newly identified no-construction-observation zone, the system 100 can set a start time (e.g., start_time=CURRENT_TIME) for the newly identified no-construction-observation zone in Step 231, thereby monitoring a creation time of the no-construction-observation zone against a time-to-live (TTL) period of the FP construction zone. Then the newly identified no-construction-observation zone exits the process in Step 233. When determining if it is an already identified no-construction-observation zone, the system 100 can check whether its creation time (1) exceeds or is equal to a product of B*TTL, B=de-blacklisting parameter, i.e., start_time−CURRENT_TIME≥B*TTL, or (2) exceeds or equal to the TTL period of the FP construction zone, i.e., start_time−CURRENT_TIME≥TTL in Step 235. If no, the no-construction-observation zone exits the process in Step 237. If yes, the system 100 removes/de-blacklists the FP construction zone from the blacklist in Step 239.

In one embodiment, the system 100 can determine the parameter values A and B_based on ground truth data on the actual roadwork locations, start/end time, and actual non-roadwork locations via a heuristic process. In one embodiment, the system 100 can tune the parameter values of A and B based on the ground truth data from time to time, periodically, upon determining a newly identified FP construction zone, etc. In one embodiment, the system 100 can set different values of parameters A & B for functional classes, such as highways, arterials, etc., since time taken by construction work changes due to priorities and urgencies based on road type. In other embodiments, the system 100 can set different values of parameters A & B for different city and rural areas, since time taken by construction work changes due to its priorities and urgencies set by local governments.

In one embodiment, the system 100 can adjust the total number of the construction zone reports by the number of the false positive construction zones, then (1) broadcast one or more roadwork zone messages including the adjusted construction zone reports, (2) publish digital map data including the adjusted construction zone reports, etc. to the vehicles 101 traveling in the area.

In another embodiment, the system 100 can adjust the total number of the construction zone reports by the number of the false positive construction zone reports, then update a road event map layer and/or a geographic database with the adjusted construction zone reports. Such road event map layer and/or geographic database can be accessed by the vehicles 101, other vehicles traveling in the area, location-based services, etc.

In one embodiment, the system 100 may also collect real-time sensor data, and/or road event information from one or more other sources such as government/municipality agencies, local or community agencies (e.g., a police department), and/or third-party official/semi-official sources (e.g., a services platform 119, one or more services 121a-121n (collectively referred to as services 121), one or more content providers 123a-123m (collectively referred to as content providers 123), etc. as ground true data to verify false positive road event reporting rates.

In another embodiment, the sensor information can be supplemented with additional information from network-based services such as those provided by the services platform 119 and the services 121. By way of example, the services 121 can include mapping service, navigation services, and/or other data services that provide data for suppressing a false positive roadwork zone. In one embodiment, the services platform 119 and/or the services 121 can provide contextual information such as weather, traffic, etc. as well as facilitate communications (e.g., via social networking services, messaging services, crowdsourcing services, etc.) among vehicles to share road event information. In one embodiment, the services platform 119 and/or the services 121 interact with content providers 123 who provide content data (e.g., map data, imaging data, road event data, etc.) to the services platform 119 and/or the services 121. In one embodiment, the UE 109 executes an application 111 that acts as client to the mapping platform 105, the services platform 119, the services 121, and/or the content providers 123. In one embodiment, the sensor data, contextual information, and/or configuration information can be stored in a database (e.g., the geographic database 115) for use by the mapping platform 105. All information shared by the system 100 should be filtered via privacy policy and rules set by the system 100 and/or data owners, such as removing private information before sharing with third parties.

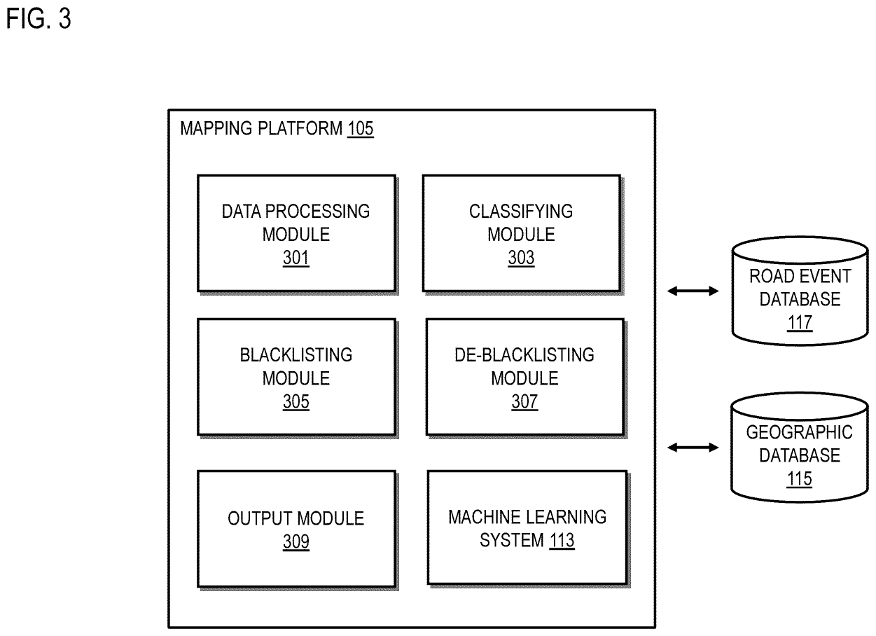

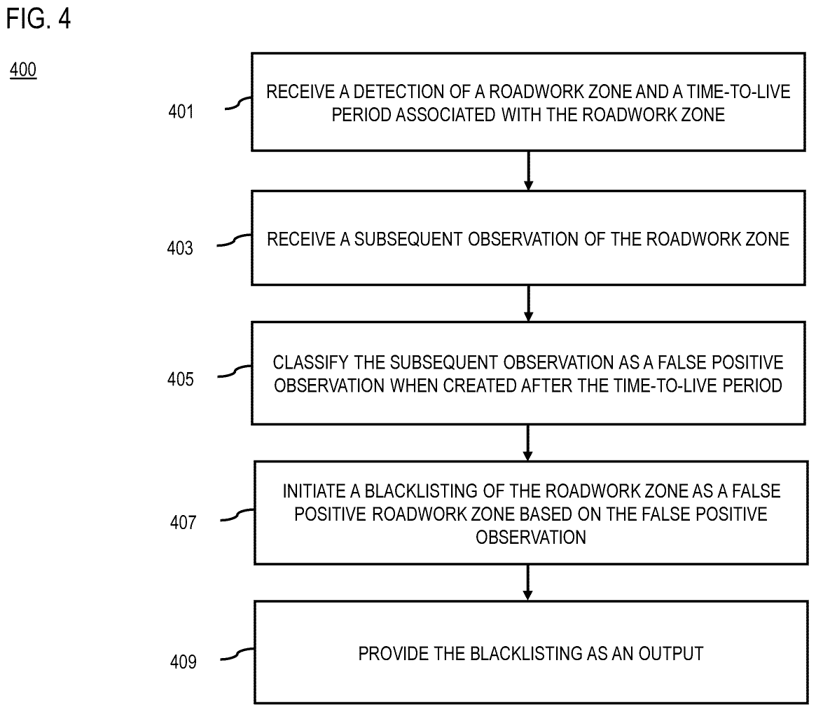

FIG. 3 is a diagram of the components of the mapping platform 105, according to example embodiment(s). By way of example, the mapping platform 105 includes one or more components for providing hybrid traffic incident identification, according to the various embodiments described herein. It is contemplated that the functions of these components may be combined or performed by other components of equivalent functionality. In one embodiment, the mapping platform 105 includes a data processing module 301, a classifying module 303, a blacklisting module 305, a de-blacklisting module 307, an output module 309, and the machine learning system 113 has connectivity to the geographic database 115 and/or the road event database 117. The above presented modules and components of the mapping platform 105 can be implemented in hardware, firmware, software, or a combination thereof. Though depicted as a separate entity in FIG. 1, it is contemplated that the mapping platform 105 may be implemented as a module of any other component of the system 100. In another embodiment, the mapping platform 105, the machine learning system 113, and/or the modules 301-309 may be implemented as a cloud-based service, local service, native application, or combination thereof. The functions of the mapping platform 105, the machine learning system 113, and/or the modules 301-309 are discussed with respect to FIGS. 4-6.

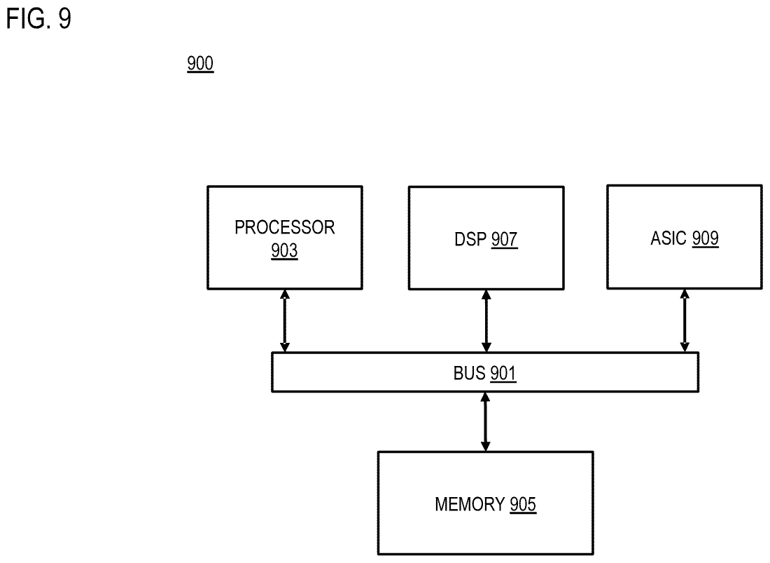

FIG. 4 is a flowchart of a process 400 for suppressing a false positive roadwork zone, according to example embodiment(s). In various embodiments, the mapping platform 105, the machine learning system 113, and/or any of the modules 301-309 may perform one or more portions of the process 400 and may be implemented in, for instance, a chip set including a processor and a memory as shown in FIG. 9. As such, the mapping platform 105 and/or the modules 301-309 can provide means for accomplishing various parts of the process 400, as well as means for accomplishing embodiments of other processes described herein in conjunction with other components of the system 100. The steps of the process 400 can be performed by any feasible entity, such as the mapping platform 105, the modules 301-309, etc. Although the process 400 is illustrated and described as a sequence of steps, it is contemplated that various embodiments of the process 400 may be performed in any order or combination and need not include all the illustrated steps.

In one embodiment, for example in step 401, the data processing module 301 can receive a detection of a roadwork zone and a time-to-live (TTL) period associated with the roadwork zone. In one embedment, the detection of the roadwork zone can be received as an output from a machine learning based automated system (e.g., pre-processing of the sensor data).

In one embodiment, in step 403, the data processing module 301 can receive a subsequent observation of the roadwork zone. The subsequent observation can be generated based on sensor data captured by at least one sensor associated with at least one vehicle traveling within proximity of the roadwork zone.

In one embodiment, in step 405, the classifying module 303 can classifying the subsequent observation as a false positive observation based on determining that the subsequent observation is created after the time-to-live period. For instance, the determining that the subsequent observation is received after the time-to-live period can be based on the time-to-live period with a scaler value (e.g., the blacking parameter A) applied. The scaler value can be determined based on ground truth roadwork zone data. In one embodiment, the scaler value is determined based on a road type (e.g., highway, arterial, or any other functional class or attribute of the road) of a road segment on which the roadwork zone is detected. In another embodiment, the scaler value is determined based on an attribute of the geographic area (e.g., city vs rural area) in which the roadwork zone is detected.

In one embodiment, in step 407, the blacklisting module 305 can initiate a blacklisting of the roadwork zone as a false positive roadwork zone based on the false positive observation.

In one embodiment, in step 409, the output module 309 can provide the blacklisting as an output. In another embodiment, the output module 309 can generate a command for operating an autonomous vehicle based on the output.

In one embodiment, the subsequent observation can be determined by processing the sensor data using a roadwork predictive machine learning model.

In one embodiment, the system 100 can determine an association between the sensor data and false positive road event reports (e.g., a scenario/cause of the false positive road event reports) based on a statistical analysis (e.g., using the machine learning system 113) of the false positive road event reports, historical false positive road event report data, or a combination thereof. Applicable machine learning algorithms may include a neural network, support vector machine (SVM), decision tree, k-nearest neighbors matching, etc.

In one embodiment, the roadwork predictive machine learning model can be built by the machine learning system 113 based on the sensor data, road event report data, ground truth data, etc. as training data. In another embodiment, a false positive scenario/cause machine learning model can be built by the machine learning system 113 based on the sensor data, false positive road event report data, ground truth data, etc. as training data, to determine set different values of parameters A & B for different false positive scenarios/causes. Understanding the scenario/cause leading to the false positive road event reports can improve the learning loops for continuous improvements of the roadwork predictive machine learning model.

For either models, the machine learning system 113 can use parameters/factors such as characteristics of a road (e.g., width, direction, curvature, lane number in each direction, lane width, surface structure, specific details like a curb stone, a centerline, even a single dash of a dashed centerline or other markings like a crosswalk or a stop line), characteristics of scenes (e.g., road objects, road furniture objects like cones, signage, benches, traffic barriers, bollards, post boxes, streetlamps, traffic lights, traffic signs, public sculptures, waste receptacles, trees, etc.), ambient data along a road link (e.g., traffic conditions, weather conditions, visibility conditions, light conditions, shadow, etc.), characteristics of the vehicle (e.g., model, age, maintenance records, etc.), characteristics of drivers/passengers (e.g., appointment/deliver schedules, comfort level preferences, etc.), map data, etc. that describe a distribution or a set of distributions of the false positive road event reports, thereby calculating scenario(s)/cause(s) of the false positive road event reports (with a respective road event type, a respective map object type, etc.) as reported from various sources, such as the vehicles 101, government/municipality agencies, local or community agencies (e.g., a police department), and/or third-party official/semi-official sources.

In one embodiment, the machine learning system 113 can select respective weights of the parameters/factors, and/or various road event information sources, for example, based on their respective reliability. In another embodiment, the machine learning system 113 can further select or assign respective correlations, relationships, etc. among the road event information sources, for determining a confidence level of a false positive road event report. In one instance, the machine learning system 113 can continuously provide and/or update the false positive cause machine learning model using, for instance, a support vector machine (SVM), neural network, decision tree, etc.

In one embodiment, the machine learning system 113 can improve the backlisting process and/or de-blacking process using feedback loops based on, for example, user behavior and/or feedback data (e.g., from traffic incident specialists). In one embodiment, the machine learning system 113 can improve the machine learning models using user behavior and/or feedback data as training data. For example, the machine learning system 113 can analyze correctly identified roadwork zone data, false positive roadwork zone data, etc. to determine the performance of the machine learning models.

In one embodiment, the de-blacklisting module 307 can initiate a de-blacklisting of the roadwork zone as the false positive roadwork zone based on determining that no subsequent observation of the roadwork zone has been received for a duration comprising the time-to-live period after the blacklisting. For instance, the determining that no subsequent observation of the roadwork zone has been received for the duration can be based on the time-to-live period with a scaler value (e.g., the de-blacking parameter B) applied.

For instance, the output module 309 can adjust a total number of road reports subsequently reported by the vehicles 101 in the geographic based on the probability in Table 1 and/or a percentage of FP construction zones. By way of example, the output module 309 can reduce a total number of road reports subsequently reported by the percentage of FP construction zones, and/or decrease a confidence of the total construction report number.

As another example, when the confidence is lower than a threshold, the output module 309 can (1) decide not to send the road event data to customers, or (2) still send the road event data yet with the low confidence value, e.g., 15% of the construction zone reports are false positive, or (3) discontinue the road event data services if 90% of the construction zone reports are false positive. For instance, an acceptable confidence threshold can be a number or a standard deviation.

In one embodiment, the output module 309 can report the percentage of FP construction zone reports, and/or the adjusted road event data to vehicles 101 and/or update the cloud. In one embodiment, the output module 309 can report the percentage of FP construction zone reports, and/or the adjusted road event data to a geographic database (e.g., the geographic database 115, and/or the road event database 117) to share with location-based services.

In one embodiment, the output module 309 can update a map layer based on the output, according to example embodiment(s). For instance, the road events can be roadwork zones (e.g., construction zones), pedestrian detecting events, signage detecting events, road divider detecting events, accident detecting events, congestion detecting events, etc.

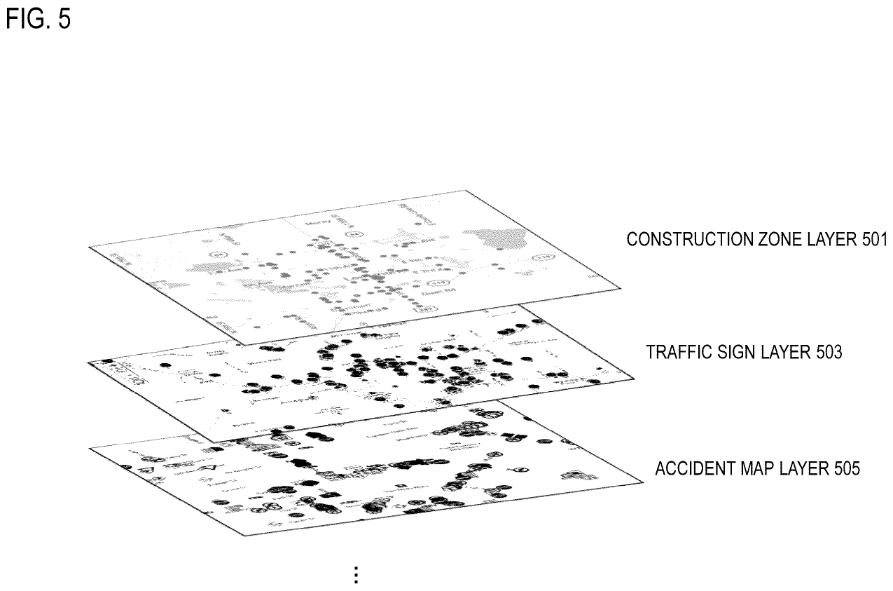

FIG. 5 is a diagram of example map layers, according to example embodiment(s). For instance, the example map layers can include a construction zone layer 501, a traffic sign layer 503, an accident map layer 505, etc. FIG. 5 is illustrative in nature, and not restrictive. Other example map layers can include a live traffic layer, a hazard warning layer, a weather layer, a cellular signal strength layer, a parking map layer, and other dynamic map object layers. Other map object layers may not change as often, yet are still applicable for a long time frame, such as a road geometry layer, a point of interest (POI) layer (e.g., a gas station layer), a 3D content layer, an electric vehicle charging station layer, a place footprint layer, etc.

In one embodiment, the output module 309 can quantify a quality of the map layer (e.g., a confidence value) based on a percentage of FP construction zones.

In another embodiment, the output module 309 can filter or reject construction zone reports from one or more sources each of which has a FP construction zone report rate higher than a threshold, and the map layer can be generated based on the remaining construction zone reports after the filtering or rejection.

In one embodiment, the output module 309 can selectively provide or publish the map layer as an output based on the quality of the map layer. For instance, the output module 309 can reduce a confidence of construction zone reporting by vehicles 101 based on the FP construction zone report rate. When the reduced confidence is below a threshold, the output module 309 can either (1) stop providing the road event reports, or (2) provide the road event reports with a reduced confidence.

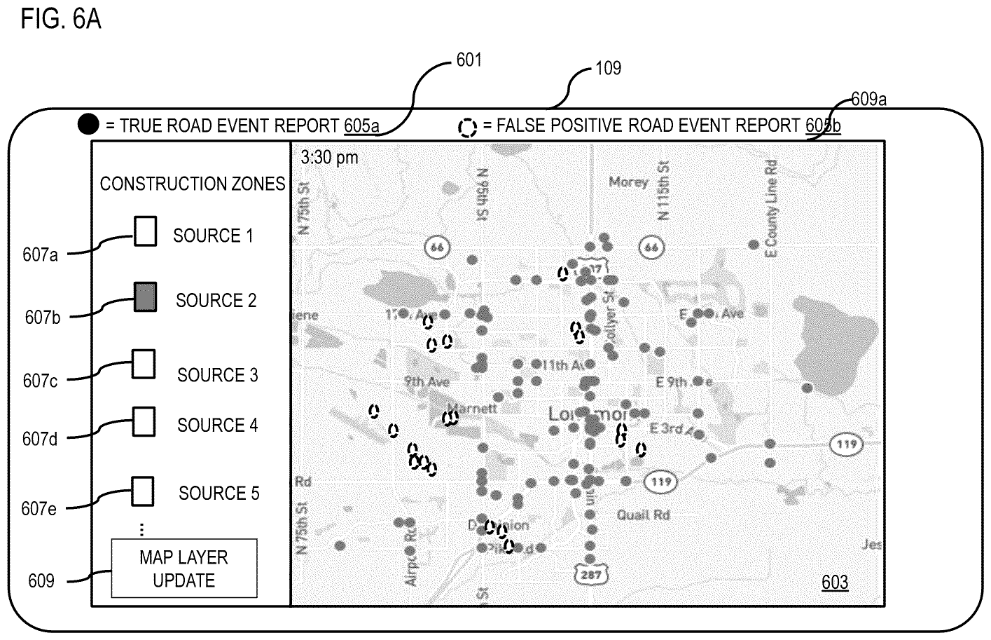

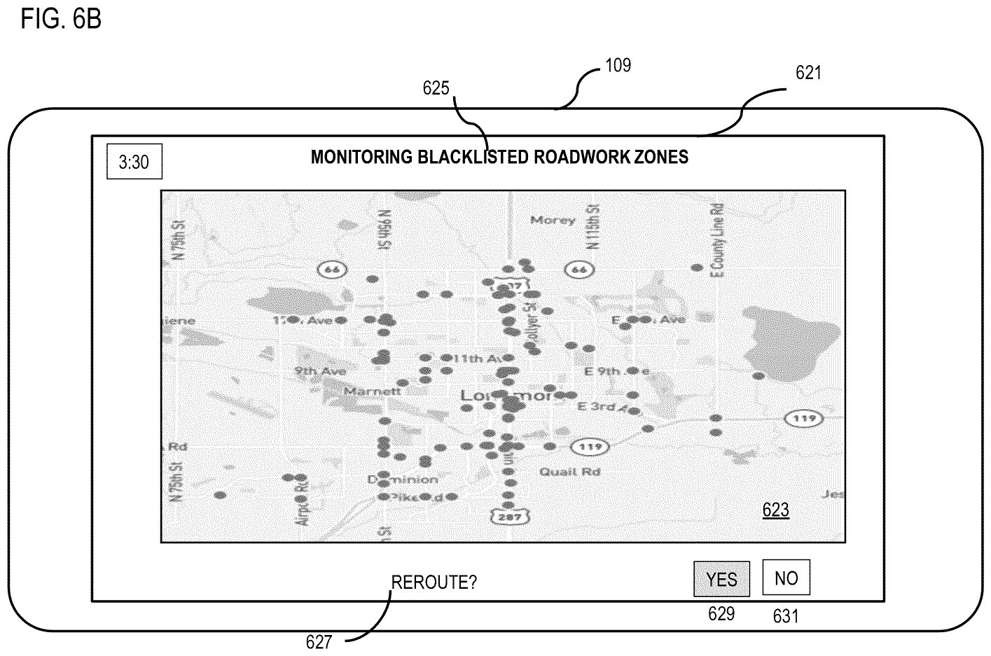

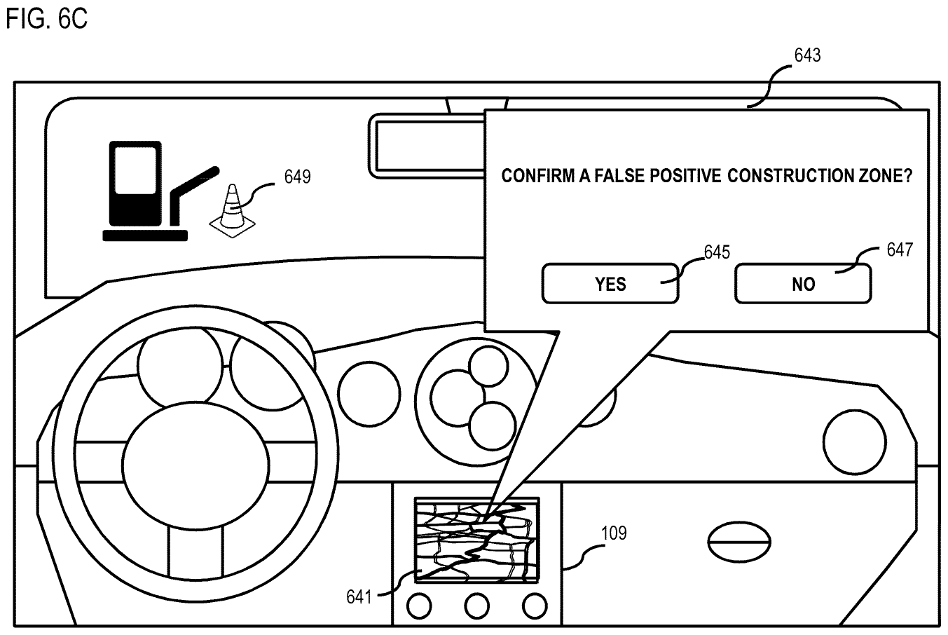

In one embodiment, the output module 309 can update a construction zone map layer based on the number of the adjusted road event reports (e.g., after suppressing the FP constriction zone reports), and present on a user interface the number of the adjusted road event reports as in FIG. 6B.

FIGS. 6A-6C are diagrams of example map user interfaces for adjusting and reporting detectable road events, according to various embodiments. Referring to FIG. 6A, in one embodiment, the system 100 can generate a user interface (UI) 601 (e.g., via the mapping platform 105, the application 111, etc.) for a UE 109 (e.g., a mobile device, a smartphone, a client terminal, etc.) that can allow a user (e.g., a mapping service provider staff, an OEM staff, an end user, etc.) to see road event data currently and/or over time (e.g., an hour, a day, a week, a month, a year, etc.) in an area presented over a map 603, upon selection of one type of road events (e.g., roadwork zones). The user can access the data based on a respective data security access level. In addition, the user can select to view one or more types of data objects within the selected road event type (e.g., roadwork zones), such as true road event reports 605a and false positive road event reports 605b in FIG. 6A. Moreover, the user can select one or more road event data sources by checking boxes 607a-607e for the selected road event type, data object type(s), etc. For instance, Source 2 (e.g., an OEM vehicle fleet with on-board LiDAR) is further selected, such that FIG. 6A shows the true road event reports 605a (e.g., in block dots) and the false positive road event reports 605b (e.g., in white dots) provided by the fleet of OEM 2. Subsequently, the user can select a button 609 to procced with the map layer update functions as discussed above.

FIG. 6B is a diagram of an example user interface (UI) 621 (e.g., of a navigation application 111) capable of presenting roadwork zone data, according to example embodiment(s). In this example, the UI 621 shown is generated for the UE 109 (e.g., a mobile device, an embedded navigation system of a vehicle 101, a client terminal, etc.) that includes a map 623, and a status indication 625 of “Monitoring blacklisted roadwork zones” by the system 100. The system 100 is monitoring roadwork zone signals/reports in the area and adjusting the roadwork zone signals/reports with a percentage of FP roadwork zones, in order to present in FIG. 6B only the filtered roadwork zone data. For instance, the system 100 can adjust the roadwork zone reports by suppressing FP roadwork instances over the area. The system 100 also presents an option of “reroute” 627 in FIG. 6B for a user can select a “yes” button 629 or a “no” button 631 with respect to rerouting. Accordingly, when the user selects the “yes” button 629, the system 100 can provide the user navigation guidance based on the adjusted roadwork zone reports.

In one instance, the UI 621 could also be presented via a headset, goggle, or eyeglass device used separately or in connection with a UE 109 (e.g., a mobile device). In one embodiment, the system 100 can present or surface the output data, the adjust traffic report data, etc. in multiple interfaces simultaneously (e.g., presenting a 2D map, a 3D map, an augmented reality view, a virtual reality display, or a combination thereof). In one embodiment, the system 100 could also present the output data to the user through other media including but not limited to one or more sounds, haptic feedback, touch, or other sensory interfaces. For example, the system 100 could present the output data through the speakers of a vehicle 101 carrying the user.

In FIG. 6C, the system 100 may provide interactive user interfaces (e.g., of UEs 109 associated with the vehicle 101) for reporting detected road events as confirmed via user inputs (e.g., crowd-sources via HERE WeGo®, etc.). In one scenario, a user interface (UI) 641 of the vehicle 101 depicts a map, and prompts the user with a popup 643: “Confirm a false positive construction zone?” An operator and/or a passenger of the vehicle 101 can select a “yes” button 645 or a “no” button 647 based on the user's observation (e.g., of a false positive construction zone 649 at a toll plaza).

For example, the user interface can present the UI 641 and/or a physical controller such as but not limited to an interface that enables voice commands, a pressure sensor on a screen or window whose intensity reflects the movement of time, an interface that enables gestures/touch interaction, a knob, a joystick, a rollerball or trackball-based interface, or other sensors. As other examples, the sensors can be any type of sensor that can detect a user's gaze, heartrate, sweat rate or perspiration level, eye movement, body movement, or combination thereof, in order to determine a user response to confirm road events. As such, the system 100 can enable a user to confirm road events (e.g., to provide the system 100 as ground truth data).

In one embodiment, the vehicle sensors 103 can include such as light sensor(s), orientation sensor(s) augmented with height sensor(s) and acceleration sensor(s), tilt sensor(s) to detect the degree of incline or decline of the vehicle along a path of travel, moisture sensor(s), pressure sensor(s), audio sensor(s) (e.g., microphone), 3D camera(s), radar system(s), LiDAR system(s), infrared camera(s), front/side/rear camera(s), ultrasound sensor(s), GPS receiver(s), windshield wiper sensor(s), ignition sensor(s), brake pressure sensor(s), head/fog/hazard light sensor(s), ABS sensor(s), ultrasonic parking sensor(s), electronic stability control sensor(s), vehicle speed sensor(s), mass airflow sensor(s), engine speed sensor(s), oxygen sensor(s), spark knock sensor(s), coolant sensor(s), manifold absolute pressure (MAF) sensor(s), fuel temperature sensor(s), voltage sensor(s), camshaft position sensor(s), throttle position sensor(s), O2 monitor(s), etc. operating at various locations in a vehicle.

In another embodiment, the sources of the sensors 103 may also include sensors configured to monitor passengers, such as O2 monitor(s), health sensor(s) (e.g. heart-rate monitor(s), blood pressure monitor(s), sleepiness sensor(s), eye gaze/strain sensor(s), etc.), etc.

By way of example, the vehicle sensors 103 can detect external conditions such as an accident, weather data, etc. Further, the vehicle sensors 103 can detect the perimeter of the vehicle, the relative distance of the vehicle from sidewalks, lane or roadways, the presence of other vehicles, trees, benches, water, potholes and any other objects, etc. Still further, the vehicle sensors 103 may provide in-vehicle navigation services, location based services (e.g., road event reporting services), etc. to the vehicles 101.

As another example, the 3D camera can be used to detect and identify objects (e.g., vehicles, pedestrians, bicycles, traffic signs and signals, road markings, etc.), to determine road events, etc. For instance, the radar data (e.g., short-range, and long-range radar) can be used to compute object distances and speeds in relation to the vehicle in real time, even during fog or rain. For instance, the short-range (24 GHz) radar supports blind spot monitoring, lane-keeping, parking, etc., while the long-range (77 GHz) radar supports distance control and braking. The LiDAR data can be used the same way as the radar data to determine object distances and speeds, and additionally to create 3D images of the detected objects and the surroundings as well as a 360-degree map around the vehicle. The redundancy and overlapping sensor capabilities ensure autonomous vehicles to operate in a wide range of environmental and lighting conditions (e.g., rain, a jaywalking pedestrian at night, etc.).

In one embodiment, the sensor data is transmitted to the system 100 via V2X communication. A V2X (vehicle-to-everything) communication system can incorporate specific types of communication such as V2I (vehicle-to-infrastructure), V2N (vehicle-to-network), V2V (vehicle-to-vehicle), V2P (vehicle-to-pedestrian), V2D (vehicle-to-device), V2G (vehicle-to-grid), etc. In one embodiment, the V2X communication information can include any information between a vehicle and any entity that may affect the vehicle operation, such as forward collision warning, lane change warning/blind spot warning, emergency electric brake light warning, intersection movement assist, emergency vehicle approaching, roadworks warning, platooning, etc.

In one embodiment, the system 100 can process the sensor data to determine road events, while the V2X communication is optional. In another embodiment, the system 100 can process the sensor data to validate a FP road event reports.

In one embodiment, the system 100 can process the sensor data for detecting e.g., objects, the environment, weather, etc., and determine a FP road event.

The above-discussed embodiments allow suppressing false positive road event reports, and adjusting a total number of subsequently road event reports, as well as determining/updating scenarios/causes of false positive road event reports using machine learning, etc.

Returning to FIG. 1, in one embodiment, the mapping platform 105 has connectivity over the communication network 107 to the services platform 119 (e.g., an OEM platform) that provides services 121 (e.g., probe and/or sensor data collection services). By way of example, the services 121 may also be other third-party services and include mapping services, navigation services, traffic incident services, travel planning services, notification services, social networking services, content (e.g., audio, video, images, etc.) provisioning services, application services, storage services, contextual information determination services, location-based services, information-based services (e.g., weather, news, etc.), etc. In one embodiment, the services platform 119 uses the output (e.g. lane-level dangerous slowdown event detection and messages) of the mapping platform 105 to provide services such as navigation, mapping, other location-based services, etc.

In one embodiment, the mapping platform 105 may be a platform with multiple interconnected components. The mapping platform 105 may include multiple servers, intelligent networking devices, computing devices, components, and corresponding software for providing parametric representations of lane lines. In addition, it is noted that the mapping platform 105 may be a separate entity of the system 100, a part of the services platform 119, a part of the one or more services 121, or included within the vehicles 101 (e.g., an embedded navigation system).

In one embodiment, content providers 123 may provide content or data (e.g., including probe data, sensor data, etc.) to the mapping platform 105, the UEs 109, the applications 111, the geographic database 115, the services platform 119, the services 121, and the vehicles 101. The content provided may be any type of content, such as map content, textual content, audio content, video content, image content, etc. In one embodiment, the content providers 123 may provide content that may aid in localizing a vehicle path or trajectory on a lane of a digital map or link. In one embodiment, the content providers 123 may also store content associated with the mapping platform 105, the geographic database 115, the services platform 119, the services 121, and/or the vehicles 101. In another embodiment, the content providers 123 may manage access to a central repository of data, and offer a consistent, standard interface to data, such as a repository of the geographic database 115.

By way of example, the UEs 109 are any type of embedded system, mobile terminal, fixed terminal, or portable terminal including a built-in navigation system, a personal navigation device, mobile handset, station, unit, device, multimedia computer, multimedia tablet, Internet node, communicator, desktop computer, laptop computer, notebook computer, netbook computer, tablet computer, personal communication system (PCS) device, personal digital assistants (PDAs), audio/video player, digital camera/camcorder, positioning device, fitness device, television receiver, radio broadcast receiver, electronic book device, game device, or any combination thereof, including the accessories and peripherals of these devices, or any combination thereof. It is also contemplated that a UE 109 can support any type of interface to the user (such as “wearable” circuitry, etc.). In one embodiment, a UE 109 may be associated with a vehicle 101 (e.g., a mobile device) or be a component part of the vehicle 101 (e.g., an embedded navigation system). In one embodiment, the UEs 109 may include the mapping platform 105 to provide hybrid traffic incident identification.

In one embodiment, as mentioned above, the vehicles 101, for instance, are part of a probe-based system for collecting probe data and/or sensor data for detecting traffic incidents (e.g., dangerous slowdown events) and/or measuring traffic conditions in a road network. In one embodiment, each vehicle 101 is configured to report probe data as probe points, which are individual data records collected at a point in time that records telemetry data for that point in time. In one embodiment, the probe ID can be permanent or valid for a certain period of time. In one embodiment, the probe ID is cycled, particularly for consumer-sourced data, to protect the privacy of the source.

In one embodiment, a probe point can include attributes such as: (1) probe ID, (2) longitude, (3) latitude, (4) heading, (5) speed, and (6) time. The list of attributes is provided by way of illustration and not limitation. Accordingly, it is contemplated that any combination of these attributes or other attributes may be recorded as a probe point. For example, attributes such as altitude (e.g., for flight capable vehicles or for tracking non-flight vehicles in the altitude domain), tilt, steering angle, wiper activation, etc. can be included and reported for a probe point. In one embodiment, the vehicles 101 may include sensors 103 for reporting measuring and/or reporting attributes. The attributes can also be any attribute normally collected by an on-board diagnostic (OBD) system of the vehicle 101, and available through an interface to the OBD system (e.g., OBD II interface or other similar interface).

The probe points can be reported from the vehicles 101 in real-time, in batches, continuously, or at any other frequency requested by the system 100 over, for instance, the communication network 107 for processing by the mapping platform 105. The probe points also can be map matched to specific road links stored in the geographic database 115. In one embodiment, the system 100 (e.g., via the mapping platform 105) can generate probe traces (e.g., vehicle paths or trajectories) from the probe points for an individual probe so that the probe traces represent a travel trajectory or vehicle path of the probe through the road network.

In one embodiment, as previously stated, the vehicles 101 are configured with various sensors (e.g., vehicle sensors 103) for generating or collecting probe data, sensor data, related geographic/map data, etc. In one embodiment, the sensed data represents sensor data associated with a geographic location or coordinates at which the sensor data was collected. By way of example, the vehicle sensors 103 may include a RADAR system, a LiDAR system, global positioning sensor for gathering location data (e.g., GPS), a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, velocity sensors mounted on a steering wheel of the vehicles 101, switch sensors for determining whether one or more vehicle switches are engaged, and the like. Though depicted as automobiles, it is contemplated the vehicles 101 can be any type of vehicle manned or unmanned (e.g., cars, trucks, buses, vans, motorcycles, scooters, drones, etc.) that travel through road segments of a road network.

Other examples of sensors 103 of the vehicle 101 may include light sensors, orientation sensors augmented with height sensors and acceleration sensor (e.g., an accelerometer can measure acceleration and can be used to determine orientation of the vehicle), tilt sensors to detect the degree of incline or decline of the vehicle 101 along a path of travel (e.g., while on a hill or a cliff), moisture sensors, pressure sensors, etc. In a further example embodiment, sensors 103 about the perimeter of the vehicle 101 may detect the relative distance of the vehicle 101 from a physical divider, a lane line of a link or roadway, the presence of other vehicles, pedestrians, traffic lights, potholes and any other objects, or a combination thereof. In one scenario, the vehicle sensors 103 may detect weather data, traffic information, or a combination thereof. In one embodiment, the vehicles 101 may include GPS or other satellite-based receivers to obtain geographic coordinates from satellites 125 for determining current location and time. Further, the location can be determined by visual odometry, triangulation systems such as A-GPS, Cell of Origin, or other location extrapolation technologies.

In one embodiment, the UEs 109 may also be configured with various sensors (not shown for illustrative convenience) for acquiring and/or generating probe data and/or sensor data associated with a vehicle 101, a driver, other vehicles, conditions regarding the driving environment or roadway, etc. For example, such sensors may be used as GPS receivers for interacting with the one or more satellites 125 to determine and track the current speed, position, and location of a vehicle 101 travelling along a link or roadway. In addition, the sensors may gather tilt data (e.g., a degree of incline or decline of the vehicle during travel), motion data, light data, sound data, image data, weather data, temporal data and other data associated with the vehicles 101 and/or UEs 109. Still further, the sensors may detect local or transient network and/or wireless signals, such as those transmitted by nearby devices during navigation of a vehicle along a roadway (Li-Fi, near field communication (NFC)) etc.

It is noted therefore that the above described data may be transmitted via the communication network 107 as probe data (e.g., GPS probe data) according to any known wireless communication protocols. For example, each UE 109, application 111, user, and/or vehicle 101 may be assigned a unique probe identifier (probe ID) for use in reporting or transmitting said probe data collected by the vehicles 101 and/or UEs 109. In one embodiment, each vehicle 101 and/or UE 109 is configured to report probe data as probe points, which are individual data records collected at a point in time that records telemetry data.

In one embodiment, the mapping platform 105 retrieves aggregated probe points gathered and/or generated by the vehicle sensors 103 and/or the UE 109 resulting from the travel of the UEs 109 and/or vehicles 101 on a road segment of a road network. In one instance, the geographic database 115 stores a plurality of probe points and/or trajectories generated by different vehicle sensors 103, UEs 109, applications 111, vehicles 101, etc. over a period while traveling in a monitored area. A time sequence of probe points specifies a trajectory—i.e., a path traversed by a UE 109, application 111, vehicle 101, etc. over the period.

In one embodiment, the communication network 107 of the system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, 5G networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

By way of example, the vehicles 101, vehicle sensors 103, mapping platform 105, UEs 109, applications 111, services platform 119, services 121, content providers 123, and/or satellites 125 communicate with each other and other components of the system 100 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a datalink (layer 2) header, an internetwork (layer 3) header and a transport (layer 4) header, and various application (layer 5, layer 6 and layer 7) headers as defined by the OSI Reference Model.

The processes described herein for suppressing a false positive roadwork zone may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

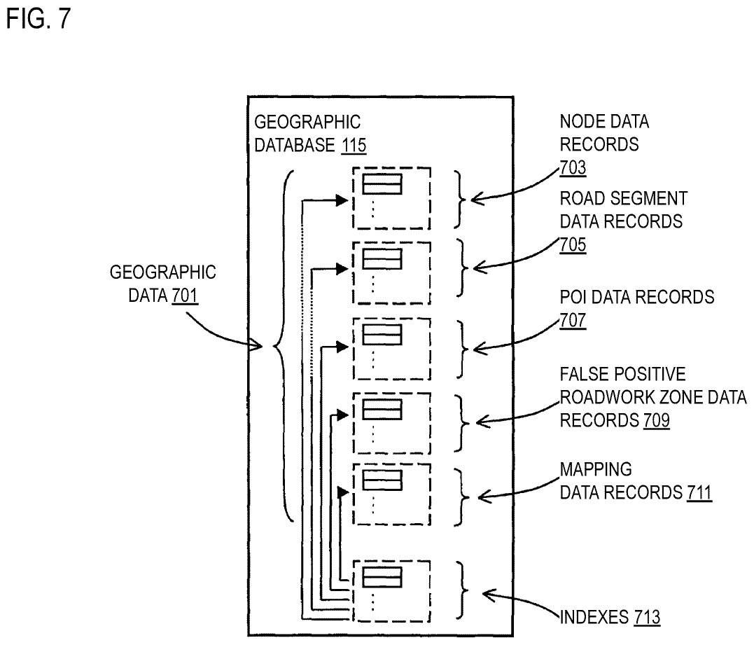

FIG. 7 is a diagram of a geographic database (such as the database 115), according to one embodiment. In one embodiment, the geographic database 115 includes geographic data 701 used for (or configured to be compiled to be used for) mapping and/or navigation-related services, such as for video odometry based on the parametric representation of lanes include, e.g., encoding and/or decoding parametric representations into lane lines. In one embodiment, the geographic database 115 include high resolution or high definition (HD) mapping data that provide centimeter-level or better accuracy of map features. For example, the geographic database 115 can be based on Light Detection and Ranging (LiDAR) or equivalent technology to collect very large numbers of 3D points depending on the context (e.g., a single street/scene, a country, etc.) and model road surfaces and other map features down to the number lanes and their widths. In one embodiment, the mapping data (e.g., mapping data records 711) capture and store details such as the slope and curvature of the road, lane markings, roadside objects such as signposts, including what the signage denotes. By way of example, the mapping data enable highly automated vehicles to precisely localize themselves on the road.

In one embodiment, geographic features (e.g., two-dimensional or three-dimensional features) are represented using polygons (e.g., two-dimensional features) or polygon extrusions (e.g., three-dimensional features). For example, the edges of the polygons correspond to the boundaries or edges of the respective geographic feature. In the case of a building, a two-dimensional polygon can be used to represent a footprint of the building, and a three-dimensional polygon extrusion can be used to represent the three-dimensional surfaces of the building. It is contemplated that although various embodiments are discussed with respect to two-dimensional polygons, it is contemplated that the embodiments are also applicable to three-dimensional polygon extrusions. Accordingly, the terms polygons and polygon extrusions as used herein can be used interchangeably.

In one embodiment, the following terminology applies to the representation of geographic features in the geographic database 115.

“Node”—A point that terminates a link.

“Line segment”—A line connecting two points.

“Link” (or “edge”)—A contiguous, non-branching string of one or more line segments terminating in a node at each end.

“Shape point”—A point along a link between two nodes (e.g., used to alter a shape of the link without defining new nodes).

“Oriented link”—A link that has a starting node (referred to as the “reference node”) and an ending node (referred to as the “non reference node”).

“Simple polygon”—An interior area of an outer boundary formed by a string of oriented links that begins and ends in one node. In one embodiment, a simple polygon does not cross itself.

“Polygon”—An area bounded by an outer boundary and none or at least one interior boundary (e.g., a hole or island). In one embodiment, a polygon is constructed from one outer simple polygon and none or at least one inner simple polygon. A polygon is simple if it just consists of one simple polygon, or complex if it has at least one inner simple polygon.

In one embodiment, the geographic database 115 follows certain conventions. For example, links do not cross themselves and do not cross each other except at a node. Also, there are no duplicated shape points, nodes, or links. Two links that connect each other have a common node. In the geographic database 115, overlapping geographic features are represented by overlapping polygons. When polygons overlap, the boundary of one polygon crosses the boundary of the other polygon. In the geographic database 115, the location at which the boundary of one polygon intersects they boundary of another polygon is represented by a node. In one embodiment, a node may be used to represent other locations along the boundary of a polygon than a location at which the boundary of the polygon intersects the boundary of another polygon. In one embodiment, a shape point is not used to represent a point at which the boundary of a polygon intersects the boundary of another polygon.

As shown, the geographic database 115 includes node data records 703, road segment or link data records 705, POI data records 707, false positive roadwork zone data records 709, mapping data records 711, and indexes 713, for example. More, fewer or different data records can be provided. In one embodiment, additional data records (not shown) can include cartographic (“carto”) data records, routing data, and maneuver data. In one embodiment, the indexes 713 may improve the speed of data retrieval operations in the geographic database 115. In one embodiment, the indexes 713 may be used to quickly locate data without having to search every row in the geographic database 115 every time it is accessed. For example, in one embodiment, the indexes 713 can be a spatial index of the polygon points associated with stored feature polygons.

In exemplary embodiments, the road segment data records 705 are links or segments representing roads, streets, or paths, as can be used in the calculated route or recorded route information for determination of one or more personalized routes. The node data records 703 are end points (such as intersections) corresponding to the respective links or segments of the road segment data records 705. The road link data records 705 and the node data records 703 represent a road network, such as used by vehicles, cars, and/or other entities. Alternatively, the geographic database 115 can contain path segment and node data records or other data that represent pedestrian paths or areas in addition to or instead of the vehicle road record data, for example.

The road/link segments and nodes can be associated with attributes, such as geographic coordinates, street names, address ranges, speed limits, turn restrictions at intersections, and other navigation related attributes, as well as POIs, such as gasoline stations, hotels, restaurants, museums, stadiums, offices, automobile dealerships, auto repair shops, buildings, stores, parks, etc. The geographic database 115 can include data about the POIs and their respective locations in the POI data records 707. The geographic database 115 can also include data about places, such as cities, towns, or other communities, and other geographic features, such as bodies of water, mountain ranges, etc. Such place or feature data can be part of the POI data records 707 or can be associated with POIs or POI data records 707 (such as a data point used for displaying or representing a position of a city). In one embodiment, certain attributes, such as lane marking data records, mapping data records and/or other attributes can be features or layers associated with the link-node structure of the database.

In one embodiment, the geographic database 115 can also include false positive roadwork zone data records 709 for storing training data, prediction models, annotated observations, computed featured distributions, sampling probabilities, and/or any other data generated or used by the system 100 according to the various embodiments described herein. By way of example, the false positive roadwork zone data records 709 can be associated with one or more of the node records 703, road segment records 705, and/or POI data records 707 to support localization or visual odometry based on the features stored therein and the corresponding estimated quality of the features. In this way, the records 709 can also be associated with or used to classify the characteristics or metadata of the corresponding records 703, 705, and/or 707.

In one embodiment, as discussed above, the mapping data records 711 model road surfaces and other map features to centimeter-level or better accuracy. The mapping data records 711 also include lane models that provide the precise lane geometry with lane boundaries, as well as rich attributes of the lane models. These rich attributes include, but are not limited to, lane traversal information, lane types, lane marking types, lane level speed limit information, and/or the like. In one embodiment, the mapping data records 711 are divided into spatial partitions of varying sizes to provide mapping data to vehicles 101 and other end user devices with near real-time speed without overloading the available resources of the vehicles 101 and/or devices (e.g., computational, memory, bandwidth, etc. resources).

In one embodiment, the mapping data records 711 are created from high-resolution 3D mesh or point-cloud data generated, for instance, from LiDAR-equipped vehicles. The 3D mesh or point-cloud data are processed to create 3D representations of a street or geographic environment at centimeter-level accuracy for storage in the mapping data records 711.

In one embodiment, the mapping data records 711 also include real-time sensor data collected from probe vehicles in the field. The real-time sensor data, for instance, integrates real-time traffic information, weather, and road conditions (e.g., potholes, road friction, road wear, etc.) with highly detailed 3D representations of street and geographic features to provide precise real-time also at centimeter-level accuracy. Other sensor data can include vehicle telemetry or operational data such as windshield wiper activation state, braking state, steering angle, accelerator position, and/or the like.

In one embodiment, the geographic database 115 can be maintained by the content provider 123 in association with the services platform 119 (e.g., a map developer). The map developer can collect geographic data to generate and enhance the geographic database 115. There can be different ways used by the map developer to collect data. These ways can include obtaining data from other sources, such as municipalities or respective geographic authorities. In addition, the map developer can employ field personnel to travel by vehicle (e.g., vehicles 101 and/or UEs 109) along roads throughout the geographic region to observe features and/or record information about them, for example. Also, remote sensing, such as aerial or satellite photography, can be used.

The geographic database 115 can be a master geographic database stored in a format that facilitates updating, maintenance, and development. For example, the master geographic database or data in the master geographic database can be in an Oracle spatial format or other spatial format, such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data is compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle 101 or a UE 109, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received geographic database in a delivery format to produce one or more compiled navigation databases.

The processes described herein for suppressing a false positive roadwork zone may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

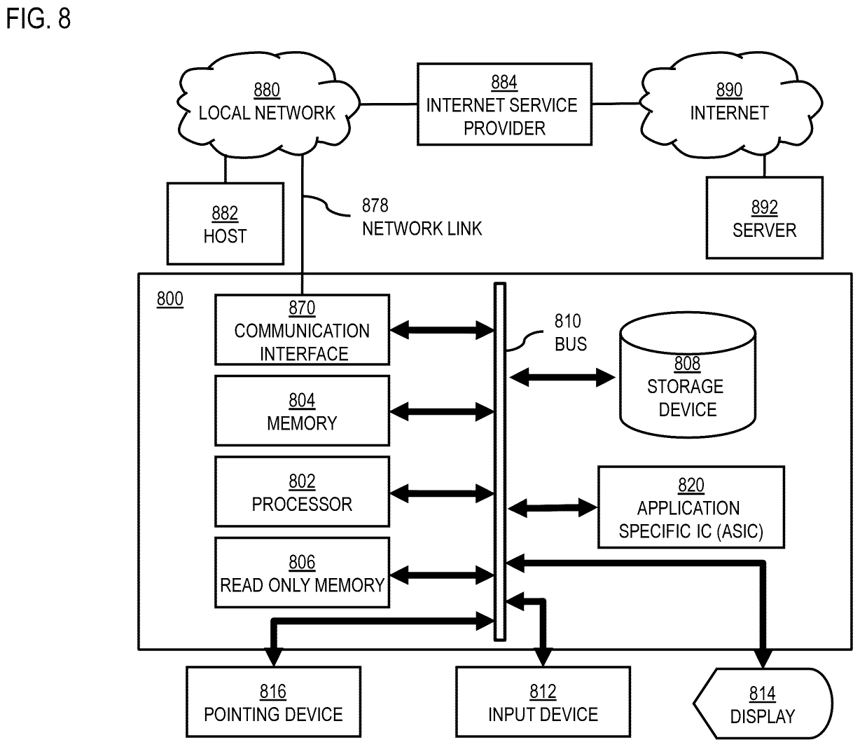

FIG. 8 illustrates a computer system 800 upon which an embodiment of the invention may be implemented. Computer system 800 is programmed (e.g., via computer program code or instructions) to suppress a false positive roadwork zone as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to suppressing a false positive roadwork zone. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for suppressing a false positive roadwork zone. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for suppressing a false positive roadwork zone, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic, or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for suppressing a false positive roadwork zone to report to the vehicles 101.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to suppress a false positive roadwork zone as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively, or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to suppress a false positive roadwork zone. The memory 905 also stores the data associated with or generated by the execution of the inventive steps.

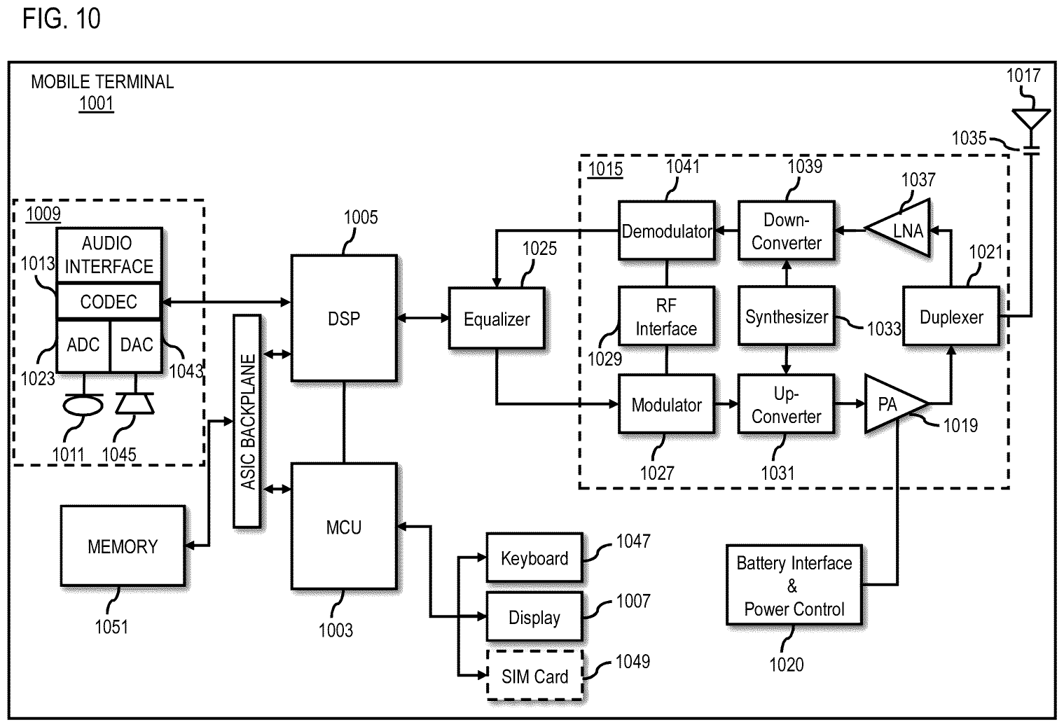

FIG. 10 is a diagram of exemplary components of a mobile terminal 1001 (e.g., handset or vehicle or part thereof) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a landline connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to suppress a false positive roadwork zone. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
receiving a detection of a roadwork zone and a time-to-live period associated with the roadwork zone;
receiving a subsequent observation of the roadwork zone, wherein the subsequent observation is generated based on sensor data captured by at least one sensor associated with at least one vehicle traveling within proximity of the roadwork zone;
classifying the subsequent observation as a false positive observation based on determining that the subsequent observation is created after the time-to-live period;
initiating a blacklisting of the roadwork zone as a false positive roadwork zone based on the false positive observation; and
providing the blacklisting as an output.

2. The method of claim 1, wherein the subsequent observation is determined by processing the sensor data using a roadwork predictive machine learning model.

3. The method of claim 1, wherein the determining that the subsequent observation is received after the time-to-live period is based on the time-to-live period with a scaler value applied.

4. The method of claim 3, wherein the scaler value is determined based on ground truth roadwork zone data.

5. The method of claim 3, wherein the scaler value is determined based on a road type of a road segment on which the roadwork zone is detected.

6. The method of claim 3, wherein the scaler value is determined based on an attribute of the geographic area in which the roadwork zone is detected.

7. The method of claim 1, further comprising:
initiating a de-blacklisting of the roadwork zone as the false positive roadwork zone based on determining that no subsequent observation of the roadwork zone has been received for a duration comprising the time-to-live period after the blacklisting.

8. The method of claim 7, wherein the determining that no subsequent observation of the roadwork zone has been received for the duration is based on the time-to-live period with a scaler value applied.

9. The method of claim 1, wherein the detection of the roadwork zone is received as an output from a machine learning based automated system.

10. The method of claim 1, further comprising:
generating a command for operating an autonomous vehicle based on the output.

11. An apparatus comprising:
at least one processor; and
at least one memory including computer program code for one or more programs,
the at least one memory and the computer program code configured to, with the at least one processor, cause the apparatus to perform at least the following,
receive a detection of a roadwork zone and a time-to-live period associated with the roadwork zone;
receive a subsequent observation of the roadwork zone, wherein the subsequent observation is generated based on sensor data captured by at least one sensor associated with at least one vehicle traveling within proximity of the roadwork zone;
classify the subsequent observation as a false positive observation based on determining that the subsequent observation is created after the time-to-live period;
initiate a blacklisting of the roadwork zone as a false positive roadwork zone based on the false positive observation; and
provide the blacklisting as an output.

12. The apparatus of claim 11, wherein the subsequent observation is determined by processing the sensor data using a roadwork predictive machine learning model.

13. The apparatus of claim 11, wherein the determining that the subsequent observation is received after the time-to-live period is based on the time-to-live period with a scaler value applied

14. The apparatus of claim 11, wherein the apparatus is further caused to:
initiate a de-blacklisting of the roadwork zone as the false positive roadwork zone based on determining that no subsequent observation of the roadwork zone has been received for a duration comprising the time-to-live period after the blacklisting.

15. The apparatus of claim 14, wherein the determining that no subsequent observation of the roadwork zone has been received for the duration is based on the time-to-live period with a scaler value applied.

16. A non-transitory computer-readable storage medium carrying one or more sequences of one or more instructions which, when executed by one or more processors, cause an apparatus to perform:
receiving a detection of a roadwork zone and a time-to-live period associated with the roadwork zone;
receiving a subsequent observation of the roadwork zone, wherein the subsequent observation is generated based on sensor data captured by at least one sensor associated with at least one vehicle traveling within proximity of the roadwork zone;
classifying the subsequent observation as a false positive observation based on determining that the subsequent observation is created after the time-to-live period;
initiating a blacklisting of the roadwork zone as a false positive roadwork zone based on the false positive observation; and
providing the blacklisting as an output.

17. The non-transitory computer-readable storage medium of claim 16, wherein the subsequent observation is determined by processing the sensor data using a roadwork predictive machine learning model.

18. The non-transitory computer-readable storage medium of claim 16, wherein the determining that the subsequent observation is received after the time-to-live period is based on the time-to-live period with a scaler value applied

19. The non-transitory computer-readable storage medium of claim 16, wherein the apparatus is caused to further perform:
initiating a de-blacklisting of the roadwork zone as the false positive roadwork zone based on determining that no subsequent observation of the roadwork zone has been received for a duration comprising the time-to-live period after the blacklisting.

20. The non-transitory computer-readable storage medium of claim 19, wherein the determining that no subsequent observation of the roadwork zone has been received for the duration is based on the time-to-live period with a scaler value applied.
